(19) United States
(12) Patent Application Publication
(10) Pub. No.: US 2012/0031719 A1
(43) Pub. Date: Feb. 9, 2012

(54) SELF-POWERED AND SELF-SENSING MAGNETORHEOLOGICAL DAMPERS

(75) Inventors: Wei Hsin LIAO, Hong Kong (CN); Chao CHEN, Hong Kong (CN)

(73) Assignee: THE CHINESE UNIVERSITY OF HONG KONG, Hong Kong (CN)

(21) Appl. No.: 12/896,760

(22) Filed: Oct. 1, 2010

(30) Foreign Application Priority Data
Aug. 5, 2010 (CN) 201010257348.0

(51) Int. Cl. F16F 9/53; H02J 7/04

(52) U.S. Cl. 188/267.2; 320/134

(57) ABSTRACT

Disclosed is a self-powered and self-sensing MR damping device, comprising: an MR damper part having a damper piston assembly and a damper cylinder, the damper piston assembly being movable relative to the damper cylinder under an external excitation; a power generator configured to generate electrical power according to the relative movement between the damper piston and the cylinder assembly; and an electrical circuit configured to estimate said relative movement to output a damper driving current based on the estimated velocity, wherein the MR damper part is further configured to generate a damper force according to the damper driving current. An electrical circuit for the device is also provided.

### TECHNICAL FIELD

The application relates to a self-powered and self-sensing MR damping device and an electrical circuit applicable to devices that have electrical power generation, velocity sensing and MR damping capabilities.

### BACKGROUND

Vibration controls are crucial to today's increasingly high-speed dynamic systems. In an application of a magnetic field, magnetorheological (MR) fluids are one kind of smart materials that exhibit fast, reversible and tunable transition from a free-flowing state to a semi-solid state in a few milliseconds. MR fluids are very promising for semi-active vibration control because they provide a simple and fast response interface between electronic controls and mechanical devices/systems. MR dampers have attractive advantages such as controllable damping force, broad operational temperature range, fast response, and low power consumption.

The schematic of the typical MR damper based semi-active control system is illustrated in FIG. 1. As shown in FIG. 1, in the current MR damper system, a separate power supply 60 and a dynamic sensor 64 are required. The power supply 60 is used for activating electromagnetic coils inside an MR damper 62 to provide a magnetic field for the MR fluids. The sensor 64 is used to measure a dynamic response, which may comprise a displacement or velocity of a plant 61 or components in the MR damper 62. A system controller 66 uses measured signals representing the velocity in determining the control action. The current MR damper system also comprises a damper controller 67 to generate a command of voltage based on the measured signals from the system controller 66. The generated command is then applied to a current driver 68.

In the current MR damper system, as two ends of the MR damper 67 move relative to each other under an external excitation, the mechanical energy from the MR damper will be converted into heat and the converted heart will be dissipated. For example, during the everyday usage of an automobile, only 10-16% of the fuel energy is used to drive the car to overcome a resistance from a road friction and an air drag. A fair amount of fuel power is wasted when the car is running under an irregular road. In addition, the separate power supply (battery) needs to be recharged or replaced due to its limited lifetime. It also increases the installation space, weight and cost of MR damper systems.

Also, to fully take advantages of the controllable damping characteristics of the MR damper, an extra velocity/displacement sensor that measures the relative velocity/displacement of two ends of MR damper is necessary in the current MR damper system. In general, the extra sensor is separately paralleled with the MR damper. The extra dynamic sensor increases the installation space, weight and cost of MR damper systems. Besides, the connectors between the separate sensor and MR damper system lower the system reliability.

### SUMMARY

The present application provides an ideal solution for vibration mitigation systems. Under vibration excitations, a self-powered and self-sensing MR damper according to embodiments of the application will generates a required damping force automatically without the extra power supply and sensor.

In one aspect, there is provided a self-powered and self-sensing MR damping device, comprising:

an MR damper part having a damper piston assembly and a damper cylinder, the damper piston assembly being movable relative to the damper cylinder under an external excitation;

a power generator configured to generate electrical power according to the relative movement between the damper piston and the cylinder assembly; and

an electrical circuit configured to estimate said relative movement to output a damper driving current based on the estimated velocity,
wherein the MR damper part is further configured to generate a damper force according to the damper driving current.

In another aspect, there is provided a self-powered and self-sensing MR damping device, which may comprise:

an MR damper part having a damper piston assembly and a damper cylinder, the damper piston assembly being movable relative to the damper cylinder under an external excitation;

a power generator configured to generate electrical power according to the relative movement between the damper piston and said cylinder assembly; and

a sensing part configured to sense the relative movement of the damper piston assembly and the damper cylinder.

According to the above MR damping device, a part of mechanical energy from the MR damper may be converted to electricity for the usage of MR damping system itself, rather than just wasting it as heat. Also, it could measure relative velocity/displacements between two ends of MR damper without an extra sensor. Therefore, separate power supply and dynamic sensor in the current MR damping system are not needed any more. Great benefits such as energy saving, size and weight reduction, lower cost, and less maintenance could be obtained for the MR damper systems. Moreover, the reliability of MR damper system could be improved by eliminating two separate devices and their connectors.

In addition, the present application could provide system dynamic information by utilizing a sensing function. The dynamic information could be used to provide a controlling function in the MR damper system. This sensing function is applicable to different control algorithms. By using different control algorithms, the above mentioned device could have good performances for broad applications, for instances, vehicle suspensions, buildings, and prostheses.

The MR damper part, the power generator and the sensing part is not a simple combination. Instead, the three parts share some common space and components. Motion and magnetic-field interactions among three parts are also considered. In addition, some special components are designed for magnetic-field interactions.

### BRIEF DESCRIPTION OF THE DRAWINGS

FIG. 1 illustrates a typical MR damper based semi-active control system.

FIG. 2 illustrates a self-powered and self-sensing MR damper according to one embodiment of the application.

FIG. 3 illustrates an enlarged view of a portion of FIG. 2 showing details of the mechanical structure thereof.

FIG. 4 illustrates a self-powered and self-sensing MR damper according to another embodiment of the application.

FIG. 5A illustrates an enlarged view of a portion of FIG. 3 showing greater details of a multi-pole slotted power generator thereof.

FIG. 5B illustrates a multi-pole slotless power generator according to one embodiment of the application.

FIG. 6 illustrates an electrical part of a self-powered and self-sensing MR damper according to one embodiment of the application.

FIG. 7 illustrates a velocity-extraction sensing mechanism according to one embodiment of the application.

FIG. 8 illustrates distributions of magnetic fields of MR damper part and the power generator according to one embodiment of the application.

FIG. 9A illustrates a spring-based multi-pole slotted power generator according to one embodiment of the application.

FIG. 9B illustrates a spring-based multi-pole slotless power generator according to one embodiment of the application.

FIG. 10 illustrates a mechanical part having spring-based multi-pole slotless power generator and moving-spacer velocity-sensing part according to one embodiment of the application.

FIG. 11A illustrates an enlarged view of a portion of FIG. 10 showing greater details of moving-spacer velocity-sensing part thereof according to one embodiment of the application.

FIG. 11B illustrates the moving-magnet velocity-sensing part according to one embodiment of the application.

FIG. 12 illustrates the distributions of magnetic fields of a MR damper part and a moving-spacer velocity-sensing part according to one embodiment of the application.

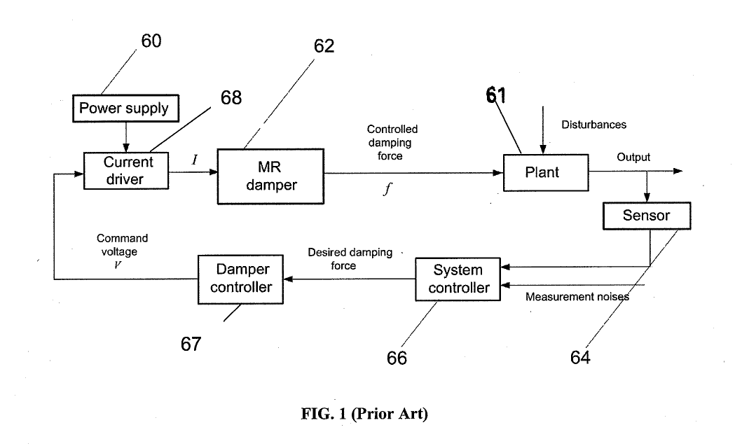

### DETAILED DESCRIPTION

Hereinafter, some embodiments of the application will be described in reference to the accompanying drawings.

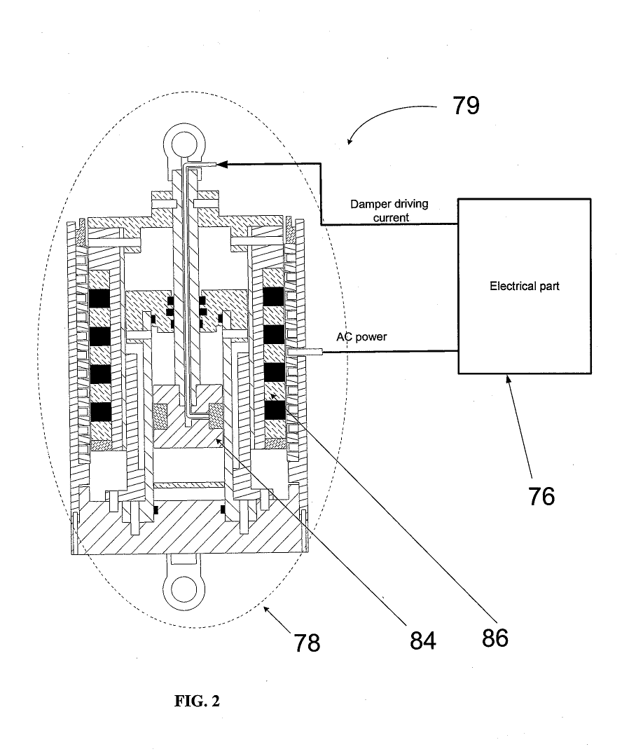

FIG. 2 illustrates a self-powered and self-sensing MR damper 79 according to one embodiment of the application. The MR damper 79 shown in FIG. 2 has a single-ended MR damper structure with multi-pole slotted power generator. The MR damper 79 carries out sensing functions by extracting velocity information from signals of power generations. This means that sensing parts of the MR damper 79 shares the same mechanical components with a power generator 86 of the MR damper 79.

As shown in FIG. 2, the MR damper 79 comprises an electrical part 76 and a mechanical part 78. Hereinafter, the mechanical part 78 will be discussed first.

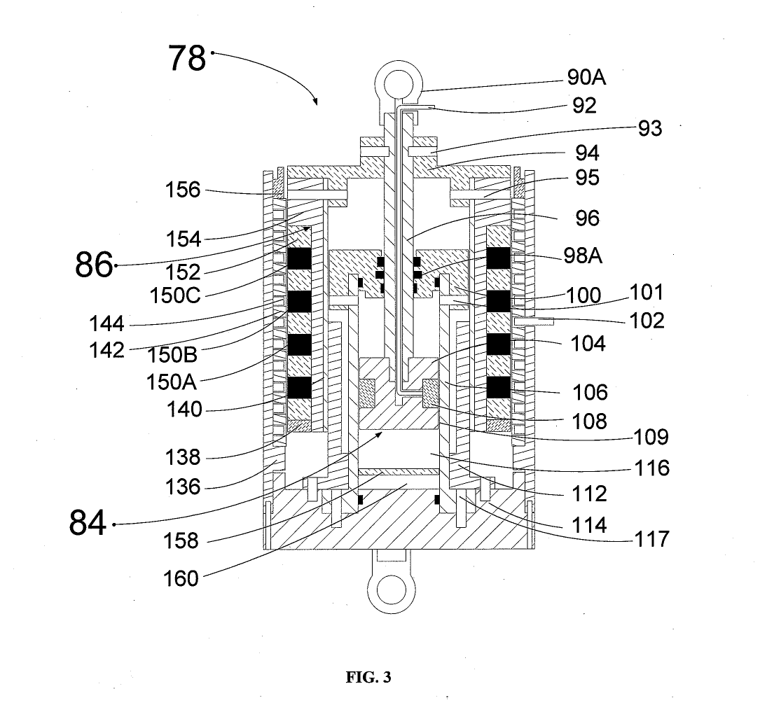

Referring to FIG. 3, the mechanical part 78 according to one embodiment of the application is illustrated. The mechanical part 78 may comprise a MR damper part 84 and a power generator 86. The power generator 86 may be of a multi-pole slotted linear generator. As shown, the power generator 86 is concentric with the MR damper part 84, and is radially outside of the MR damper part 84. That is, the MR damper part 84 is inside the power generator 86. In one aspect, this arrangement has a smaller axial size (length) than the conventional axial and outside arrangement, so that it could be very useful when an axial installment space (length) is limited. In the other aspect, the most useful part of the mechanical part 78 is the exterior part for generating the magnetic field and electricity; and the interior part of the mechanical part 78 is usually used for mounting and less important than the exterior part. Since the MR damper part 84 is used as the interior part, the interior space of the mechanical part 78 is better utilized than the conventional axial and outside arrangement. The space and components of MR damper part 84 are fully utilized. The power generation ability of the power generator 86 may increase significantly while the size (diameter) only increases slightly.

The MR damper part 84 may comprise a hydraulic cylinder 106 normally made from a high-permeability material, such as low-carbon steel. In this embodiment, the cylinder 106 provides a cylindrical hollow 116 to house fluids, e.g., MR fluids, air, oil, and/or other liquids or materials/components. The cylinder 106 is closed by two non-magnetic covers 100 and 114 at its two ends. They are assembled together to form a partially closed assembly.

The MR damper part 84 may also comprise at least one piston rod 96. The piston rod 96 is in sliding fit with the hydraulic cylinder 106 through two central holes in the covers 100 and 114. The piston rod 96 is non-magnetic. Seal components 98A, which may be bushings, O rings, lubricants, bearings and/or combined sealers, centralize and provide supports to the rod 96. Additionally, the piston rods 96 is configured as axially slidable without touching covers 110 and 114, and is further configured to seal the MR fluids inside the hollow 116.

The MR damper part 84 may also comprise a piston assembly 104 connected to the piston rod 96 by screws or welding. The piston assembly 104 is axially slidable within the cylinder 106 by guiding of the seal components 98A, and keeps centralizing or to be aligned within the cylinder 106. The piston assembly 104 is preferably manufactured by a high-permeability material with at least one spool and coil winding. In this embodiment, one coil winding 108 is shown. The MR damper part 84 may also comprise one rod-volume compensator. In this embodiment, an accumulator 160 is used, which has a floating piston 158.

A gap between the inner wall (diameter) of the hydraulic cylinder 106 and the outer wall (diameter) of the piston 104 forms a working portion of MR fluids, i.e. an annular fluid orifice 109. The coil winding 108 may be configured to create a magnetic field that affects the MR fluids in the fluid orifice 109. As the piston rod 96 moves under an external excitation, the MR fluids will flow through the annular orifice 109.

The coil winding 108 may be formed as a solenoid in this embodiment to generate magnetic fields. The coil winding 108 is interconnected to the electrical part 76 by wires 92. The wires 92 exit through the damper part by wire holes in the piston 104 and the piston rod 96. When an electrical current is applied to the coil winding 108, a magnetic field is generated to solidify the MR fluids in the annular orifice 109. Then the yield strength of MR fluids in the annular orifice 109 is increased, and thus the damping force of MR damper part 84 is increased. By adjusting input currents of coil winding 108, the damping force of MR damper part 84 could be controlled. The piston rod 96 has a threaded rod end mated with an upper connector 90A.

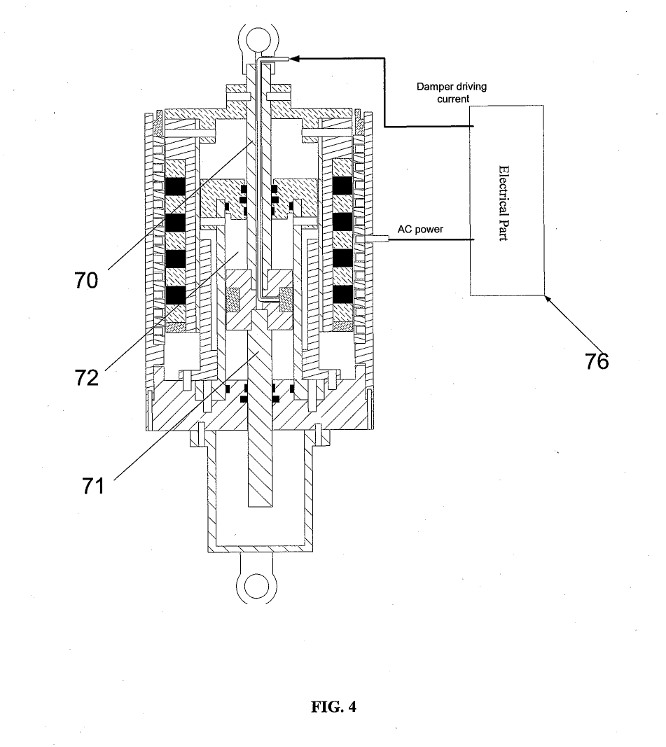

FIG. 4 illustrates a self-powered and self-sensing MR damper according to another embodiment of the application. In this embodiment, the MR damper is configured with a double-ended MR damper structure with a multi-pole slotted power generator. Different from the single-ended MR damper structure as shown in FIGS. 2 and 3, the double-ended structure has two piston rods 70 and 71. As an example, the piston rods 70 and 71 have the same diameter, so there is no volume change of a hollow 72 containing the MR fluids. The rod-volume compensator, the accumulator or other similar devices are not required in this embodiment.

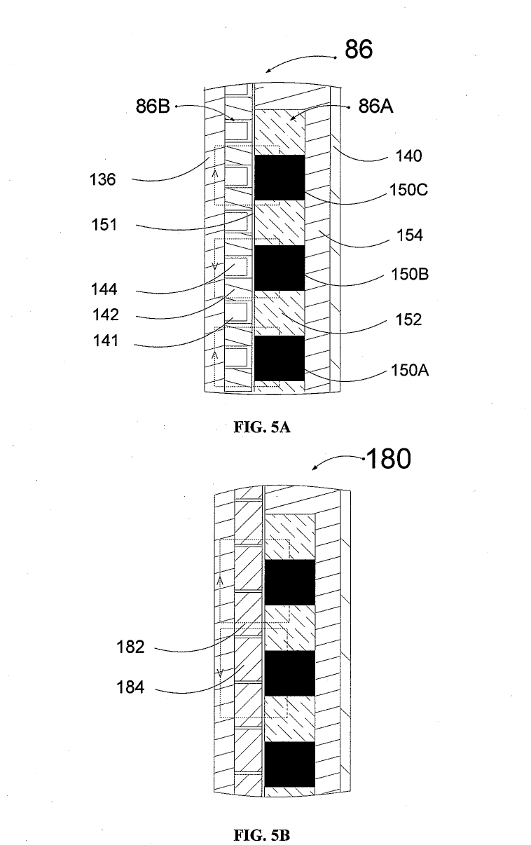

There are at least four different configurations for the power generator 86. A multi-pole slotted linear generator 86 is shown in FIG. 5A, which illustrates an enlarged view of a portion of FIG. 3. In general, the generator 86 is concentric with and radially outside the MR damper part 84 as mentioned in the above. The term “multi-pole” means the power generator 86 has multiple groups of permanent magnets and coils arranged specially. In one aspect, the special arrangement of the multiple groups is configured such that the generated power in every coil could be fully utilized. In the other aspect, this arrangement could be configured such that the magnetic flux runs in a controlled path, which could reduce the flux leakage sand enhance the strength of the magnetic field. These two aspects make the multi-pole power generator 86 have high power generation efficiency.

As shown in FIG. 5A, the power generator 86 comprises an inner part 86A and an outer part 86B. The inner part 86A comprises at least one pole piece and permanent magnet. Four permanent magnets and five pole pieces are shown in FIG. 5A. The inner part 86A may also comprise a magnetic-flux shield layer 154 formed by non-magnetic materials, a high-permeability magnetic-flux guided layer 140, and a supporting plate 138. The assembly of inner part 86A is attached to the piston rod 96 by the screws or pins 93 through the connective cap 94. Therefore, the assembly of inner part 86A is movable with the piston rod 96.

In this embodiment, ring permanent magnets 150A˜C made from rare earth may be radially magnetized or axially magnetized. The polarities of the adjacent magnets 150A˜C are opposite. As shown, the magnets 150A˜C are axially magnetized for illustrative purpose. The magnets 150A˜C are stacked in pairs so that opposing magnetomotive forces drive the flux through spacers 142 segmented in the outer part 86B. The magnets 150A˜C are interspersed with high-permeability pole pieces 152 mounted on the magnetic-flux shield layer 154. When the ring magnets are radially magnetized, the materials of the pole pieces 152, the magnetic-flux shield layer 154 and the magnetic-flux guided layer 140 should accordingly be changed to non-magnetic, high-permeability and non-magnetic.

The outer part 86B may comprise at least one winding coil and at lest one spacer. Eleven winding coils 144 and twelve spacers 142 are shown in FIG. 5. The winding coils 144 are interspersed with the high-permeability spacers 142. The winding coils 144 and the spacers 142 form a slotted structure in the outer part 86B. A gap between the inner wall of the outer part 86B and the outer wall of the inner part 86A forms a working gap 151 of the power generator 86. The spacers 142 are used to increase the magnetic flux density of the working gap 151, so that high electrical power could be generated.

The outer part 86B is attached to the cylinder cover 114 of MR damper part 84 by the screws 135. Therefore, the assembly of outer part 86B is movable with the cylinder 106. In one embodiment, the outer part 86B may also comprise a high-permeability shell 136 and a locker 156.

A specially designed magnetic-flux shield layer 154 and a magnetic-flux guided layer 140 are used to minimize the mutual interferences of the magnetic fields of the power generator 86 and the damper part 84, to solve the integration problem between the power generator 86 and the damper part 84.

A guide rail 112 is connected to the cover 114, and has a relatively low surface finish. The guide rail 112 is in slide fit with the inner part assembly 86A, and insures a proper centralizing of the inner part assembly 86A when it moves with piston rod 96.

Magnetic flux paths are depicted by dashed lines in FIG. 5A. Because the inner part assembly 86A and the outer part assembly 86B are connected to the piston rod 96 and the cylinder 106 of the MR damper part 84, respectively, under vibration excitation, the relative motion between piston rod 96 and the cylinder 106 could also cause the relative linear motion between the inner part assembly 86A and the outer part assembly 86B. The relative movement between the coils 144 and the magnets 150A˜C in the outer part assembly 86B will provide a changing magnetic flux linkage through the coils 144, thus the electrical power is generated therein. Different kind or shape of coils may be interconnected according to the voltage direction of each coil to get a maximum electrical power. The electrical power is output to the electrical part 76 through wires 102.

FIG. 5B illustrates another configuration of power generator-the multi-pole slotless power generator 180. The difference between multi-pole slotless linear generator 180 and multi-pole slotted linear generator 86 as shown in FIG. 5A lies in that, there is no spacer 142 between two adjacent coils in the slotless configuration. For multi-pole slotless linear generator 180, coils 182 and 184 are arranged one by one without being separated by the spacer that has high magnetic permeability. The magnetic flux will go through the coil 182 directly. For the slotted generator 86 as shown in FIG. 5A, the magnetic flux will go through the spacer 142. This slotless generator 180 has lower power generation ability, simpler structure and smaller cogging force than the slotted generator 86.

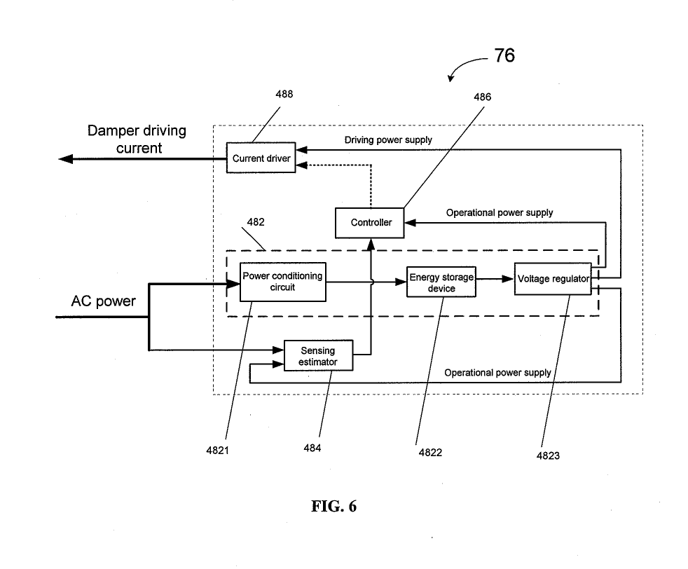

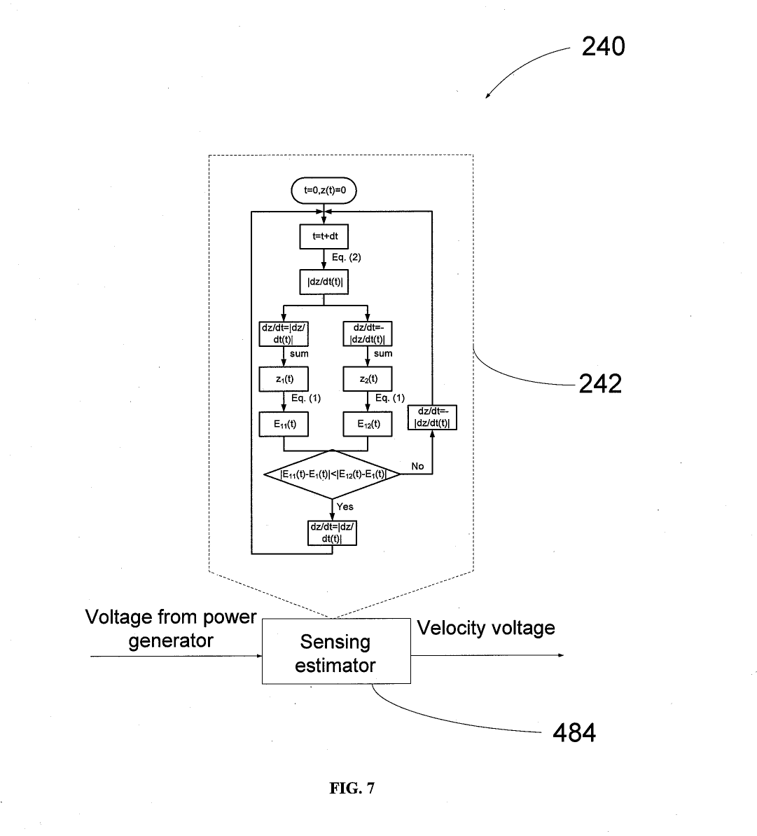

Hereinafter, the electrical part 76 will be discussed in references to FIGS. 6 and 7.

FIG. 6 illustrates the electrical part 76 of the self-powered and self-sensing MR damper 79 according to one embodiment of the application. The input of the electrical part 76 is generated AC voltages from a mechanical part 78, and the output thereof may be the driving current for the damper coil 108 to activate the magnetic field for solidifying the MR fluid. The electrical part 76 comprises an energy harvesting circuit 482, a sensing estimator 484, a controller 486, and current driver 488, which will be discussed below.

The energy harvesting circuit 482 may comprise a power conditioning circuit 4821, an energy storage device 4822, and a voltage regulator 482323. The power conditioning circuit 4821 is coupled to the energy storage device 4822. The power conditioning circuit 4821 receives the AC voltage from the mechanical part 78 and rectifies the AC voltage to DC voltage so as to provide charging voltages to the energy storage device 4822. The power conditioning circuit 4821 may include a bridge rectifier and/or voltage multiplier such as a tripler.

The energy storage device 4822 may be rechargeable batteries, capacitors or ultracapacitors. The device 4822 receives the charging voltages of power conditioning circuit 4821. The device 4822 is used to store and accumulate the harvested energy for intermittent use. In many cases, the output of harvested electrical energy of storage device 4822 may be not appropriate for load use directly (e.g., the required working power supply of the controller 486 may be 3.3 Volt, while the output voltage of storage device 4822 may be 12 Volt). Therefore, the voltage regulator 4823 is utilized to adjust the voltage received from the energy storage device 4822 to appropriate values that could be used for loads. The voltage regulator 4823 will output the electrical power to the sensing estimator 484, the controller 486 and current driver 488. The majority of the electrical power is for the current driver 488, because this branch of power is used for driving the MR damper coil 108 finally. According to one embodiment, the physical circuits in the voltage regulator 4823 may be DC-DC circuits. The voltage regulator 4823 is designed to regulate the output voltages to appropriate values (e.g. the power supply voltages for the controller 486, the sensing estimator 484, and the current driver 488 may be ±3.3 V, ±5 V, and 12 V, respectively).

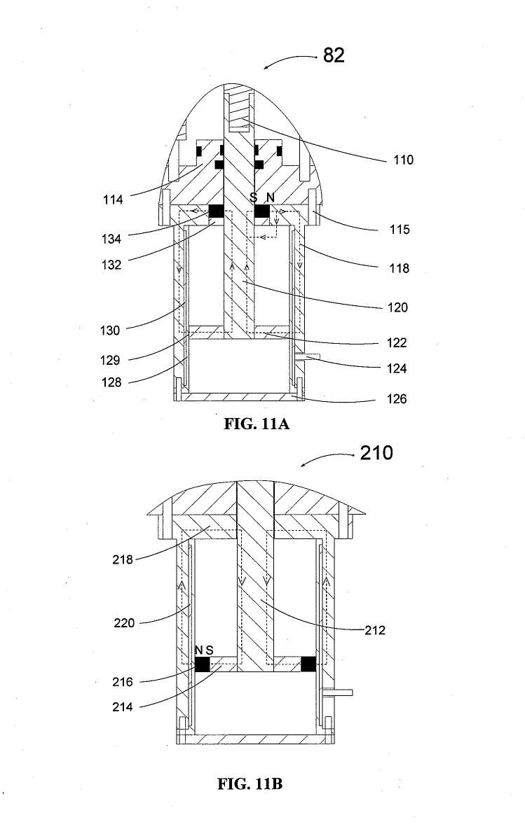

A sensing estimator 484 receives the AC power signals from the power generator 86 or the sensing voltages from the sensing part 82, and outputs the relative velocity of the two ends of MR damper. The sensing estimator 484 may comprise an analog amplifier if it receives a sensing voltage from the moving-spacer velocity-sensing part 82 of the mechanical part 220, which is proportional to the relative velocity. The moving-spacer velocity-sensing part 82 will be discussed in reference to FIG. 11A latter. Alternatively, it may comprise a digital processor that runs the estimation algorithm 242 and has A/D and/or D/A conversions, if it receives AC power signal from the power generator 86.

FIG. 7 illustrates a velocity-sensing process 242 deployed in the sensing estimator 484 according to one embodiment of the application. The process 242 utilizes a portion of the power voltage from the generator as the original sensing voltage, and then the voltage is processed by the sensing estimator 484. According to one embodiment of the application, the power voltage from the generator may be the voltage from the multi-pole slotted generator 86 or the multi-pole slotless generator 180. For an illustrative purpose, the multi-pole slotted linear generator 86 as shown in FIG. 5A is used herein.

The relative velocity between the two ends of self-powered and self-sensing MR damper is identical with the relative velocity between the inner part 86A and the outer part 86B. The generated voltages of two adjacent coils 141 and 144 (as shown in FIG. 5A) may be used for velocity extracting so as to obtain the relative velocity between the inner part 86A and the outer part 86B from following equations:

$$\begin{matrix}{E}_{1} = - N {φ}_{g} \frac{π}{τ} sin ( \frac{π}{τ} z ) \frac{d z}{d t} & ( 1 ) \\ \vert \frac{d z}{d t} \vert = \sqrt{\frac{{E}_{1}^{2} + {E}_{2}^{2}}{{( N {φ}_{g} \frac{π}{τ} )}^{2}}} & ( 2 )\end{matrix}$$

where E₁ and E₂ are the generated voltages of the coils 141 and 144, respectively, N is the number of turns of the coils, φ_{g} is an air-gap magnetic flux, r is a magnet pole pitch, z is a relative displacement, and dz/dt is a relative velocity.

The sensing algorithm 242 provides a method to extract the accurate velocity information. Firstly, the structural parameters (that is, N, φ_{g}, τ and z) are input to the sensing estimator 484, and then E₁ and E₂ are computed according to equation (2) to obtain the absolute value of velocity |dz/dt(t)|. Next, the absolute value is assumed to have two different signs to obtain two possible velocities, i.e. dz/dt=|dz/dt(t)|, and dz/dt=−|dz/dt(t)|. And then, the obtained two possible velocities are summed up by a common integral transform to get two computed relative displacements z₁ and z₂. Two calculated voltages E₁₁(t) and E₁₂(t) are determined by rule of equation (1). Then, it is determined whether |E₁₁(t)−E₁(t)| is less than |E₁₂(t)−E₁(t)|. If yes, dz/dt=|dz/dt(t)|; otherwise, dz/dt=−|dz/dt(t)|.

The relative velocity dz/dt could be obtained from the algorithm 242 by online processing of sensing estimator 484. Although this method requires online signal processing, the separate mechanical part 78 is not needed and the size of self-powered, self-sensing MR damper would be decreased. This method is applicable to the muti-pole linear electromagnetic power generators, and could be used for various applications, not only for MR damper systems shown in this embodiment.

The controller 486 is an essential component of the electrical part 76. It receives the velocity sensor signal from the sensing estimator 484. For some complex applications, the controller 486 may also receive some external sensing signals. The physical circuits for the controller 486 may comprise MCU, DSP et al. The controller 486 uses some readily available measurements to run certain control algorithms, and generates a command of voltage that could instruct the current driver 488 to induce a desired damping force of MR damper. The command of voltage output from the controller 486 is received by a current driver 488. The current driver 488 operates to convert input commands from the controller 486, which are in form of analog voltage, into the driving current accordingly. As mentioned in the above, the power supply of the current driver 488 is provided by the voltage regulator 4823. The physical circuits for the current driver 488 may be composed of operational amplifiers and MOS transistors. The output current of current driver 488 is applied to the MR damper coil 108 for activating MR fluids.

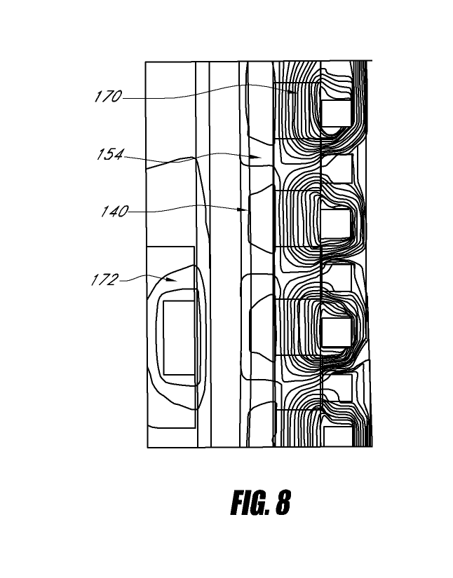

FIG. 8 illustrates distributions of magnetic fields of MR damper part 84 and the power generator 86. These magnetic-field distributions are obtained from finite element analysis. Since the power generator 86 and MR damper part 84 have their own magnetic fields while sharing some common space, the magnetic flux interferences between the power generator 86 and the MR damper part 84 should be minimized. In some embodiments, some special components are designed for magnetic-field interactions. The magnetic flux shield layer 154 and the flux guided layer 140 would be used to minimize the mutual interferences of the magnetic fields of the power generator 86 and the MR damper part 84. A magnetic field 170 from the power-generator 86 and a magnetic field 172 from the MR-damper part 84 are shown in FIG. 8. As shown, the mutual magnetic-field interferences from the fields 170 and 172 are effectively prevented.

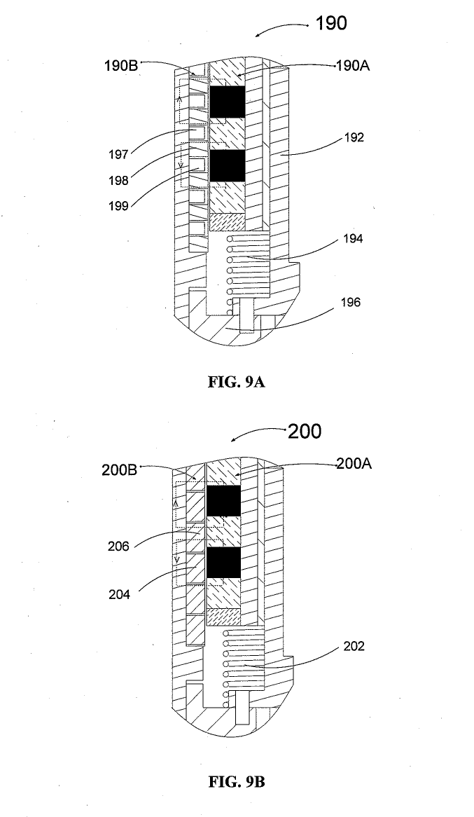

FIG. 9A illustrates a spring-based multi-pole slotted power generator 190 according to another embodiment of the application. The generator 190 may be used with a particular excitation frequency. The difference between the spring-based multi-pole slotted linear generator 190 and the multi-pole slotted linear generator 86 is that, the inner part 190A of spring-based generator 190 is attached to a spring 194, which in turn is attached to a cover 196 by welding or pressing. So, the inner part 190A is also movable with the cover 196 through the spring 194. A guide rail 192 is connected to the cover 196, and in slide fit with the inner part 190A, to insure proper centralizing of the inner part 190A as it moves. An outer part 190B of spring-based generator 190 is also attached to the cover 196. The stiffness of spring 194 is designed particularly for a vibration frequency. When the cover 196 moves under an external excitation, the external excitation would make the relative movement occur between the inner part 190A and the outer part 190B. Similar to the slotted generator 86, the term “slotted” means that there is a spacer 198 between two adjacent coils 197 and 199.

FIG. 9B illustrates a spring-based multi-pole slotless linear generator 200 according to another embodiment of the application. The generator 200 may be used with a particular excitation frequency. The difference between the spring-based multi-pole slotless linear generator 200 and the spring-based multi-pole slotted linear generator 190 is that, there is no spacer 198 between two adjacent coils 204 and 206 in a slotless configuration. For the spring-based slotless generator 200, the coils 204 and 206 are arranged one by one without being separated by a spacer that has high magnetic permeability.

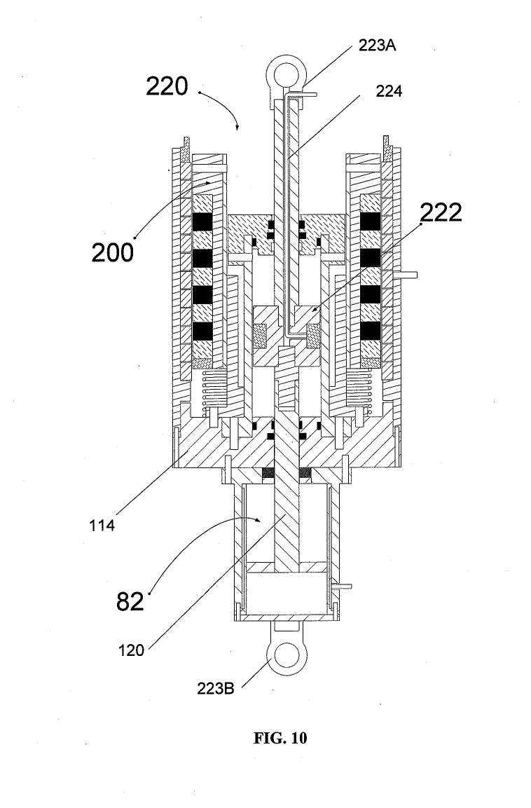

The configurations of spring-based generators 190 and 200 could not work together with the velocity-extraction configuration 240. Therefore, when the self-powered and self-sensing MR damper uses the spring based power generator 190 or 200, it needs other sensing methods. Two other sensing methods could be used and require separate mechanical components, i.e. a moving-magnet velocity-sensing part and a moving-spacer velocity-sensing part. FIG. 10 illustrates these two sensing methods.

FIG. 10 illustrates a mechanical part having spring-based multi-pole slotless power generator 200 and a moving-spacer velocity-sensing part 82. For a purpose of illustration, the mechanical part 220 comprises a multi-pole slotless power generator 200 and a moving-spacer velocity-sensing part 82. A base excitation of a cover 114 would make the multi-pole slotless power generator 200 generate an electrical power.

FIG. 11A is an enlarged view of a portion of FIG. 10 showing greater details of the moving-spacer velocity-sensing part. In general, the sensing principle is based on the electromagnetic induction. As shown in FIG. 11A, a high-permeability outer cylinder 118 is attached to the cover 114 by screws 115, thus is movable with a lower connector 223B. The connectors 223A and 223B may be coupled to the piston rod and the damper cylinder of the MR damper part, such that the relative movement of the piston rod and the damper cylinder of the MR damper part may cause the connectors 223A and 223B to move accordingly. A multi-layer coil 130 is wound on a bobbin 128 inside the outer cylinder 118. A non-magnetic plate 126 is arranged for assembly convenience.

A radially magnetized ring magnet 134 is fixed on the top of the outer cylinder 118. There is also provided a non-magnetic steel piece 132 that is attached to the outer cylinder 118 by interference fit for locating the ring magnet 134. The polarity of the magnet 134 may be opposite with that shown in FIG. 11A.

A high-permeability piston rod 120 that is slidable through a central hole of the magnet 134 is kept centralized by seal components 98B. The piston rod 120 is also attached to the non-magnetic magnetic-flux shield segment 110. The specially designed magnetic-flux shield segment 110 is used to minimize the mutual interferences of the magnetic fields of the velocity-sensing part 82 and the MR damper part 222, to solve the integration problem between the velocity-sensing part 82 and the MR damper part 222. The other end of the piston rod 120 is attached by a high-permeability washer 122.

A gap 129 between the inner wall (diameter) of the bobbin 128 and the outer wall (diameter) of the washer 122 forms a working portion 129 of the velocity-sensing part 82. The primary magnetic flux path is depicted by the dashed line in FIG. 11A. As shown, the primary magnetic flux path is a closed magnetic circuit, which may be traced from the magnet 134, through the outer cylinder 118, the coil 130, the bobbin 128 and the gap 129, the washer 122, the piston rod 120 to magnet 134. Another leakage flux path is also indicated by dashed line, but the leakage flux has little effect on the sensing. If the magnetic reluctance of steel components in the primary flux path is neglectable, the total reluctance of the primary magnetic circuit is independent of its position, but dominated by the air gap. So when the relative linear movement between the piston rod 120 and the outer cylinder 118 happens, the magnetic flux through the coil 130 keeps constant. And the number of turns of the coil 130 enclosed by the flux path will change with this movement. The coil 130 is uniformly wounded. Therefore, the total magnetic flux leakage through the coil 130 is proportional to the moving displacement. According to the Faraday's law of electromagnetic induction, the generated voltage in coil 130 is proportional to the relative velocity between piston rod 120 and the outer cylinder 118, so the sensing voltage is proportional to the relative velocity between connectors 223A and 223B. The sensing voltage is output to the electrical part 76 by wire 124.

Specifically, when the damper piston assembly 96 and the damper cylinder 106 move relative to each other under an external excitation, there will be a corresponding relative velocity between connectors 223A and 223B, which may in turn result a relative linear movement between the piston rod 120 and the outer cylinder 118 such that the number of turns of the coil 130 enclosed by the flux path through the coil 130 will change with this movement so as to generate a voltage in coil 130 that is proportional to the relative velocity between piston rod 120 and the outer cylinder 118. Hereinabove, it is described that the piston rod 120 and the outer cylinder 118 may be moved according to the movement of the damper piston assembly 96 and the damper cylinder 106, respectively. It shall be understood that the moving-spacer velocity-sensing part may be configured such that the piston rod 120 is movable according to the movement of the damper cylinder 106, and the outer cylinder 118 may be moved according to the movement of the damper piston assembly 96.

FIG. 11B illustrates another configuration of velocity-sensing part-moving-magnet configuration 210. In general, the principle of moving-magnet configuration 210 is similar to the moving-spacer configuration 82. The main difference between the moving-spacer configuration 82 and the moving-magnet configuration 210 is that, the radially magnetized ring magnet 216 moves with the piston rod 212 in the moving-magnet configuration 210, while the high-permeability spacer 122 moves with the piston rod 120 in the moving-spacer configuration 82. The magnet 216 is attached to a ring washer 214 that is mounted to the piston rod 212 by screws. The piston rod 212 moves linearly through a central hole of the outer cylinder 218. The primary magnetic flux is depicted by dashed line, and the induction voltage in coil 220 is proportional to the relative velocity between the piston rod 212 and the outer cylinder 218.

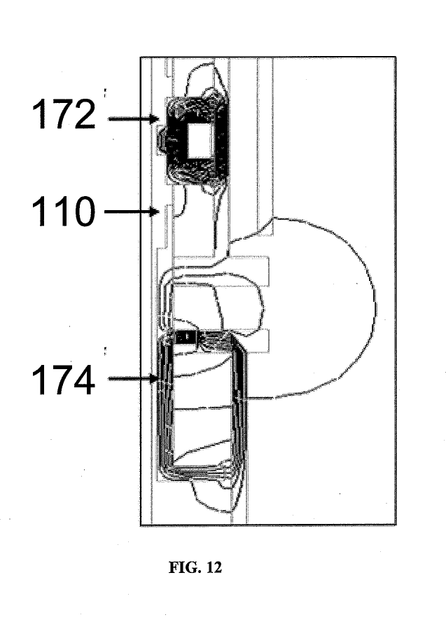

FIG. 12 illustrates distributions of magnetic fields of the MR damper part and moving-spacer velocity-sensing part. When the moving-spacer configuration 82 and the moving-magnet configuration 210 are used in the embodiments as described in the present application, the magnetic-field interferences between velocity-sensing part and the MR damper part should be considered for different applications.

Features, integers, characteristics, compounds, compositions, or combinations described in conjunction with a particular aspect, embodiment, implementation or example disclosed herein are to be understood to be applicable to any other aspect, embodiment, implementation or example described herein unless incompatible therewith. All of the features disclosed in this application (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments and extends to any novel one, or any novel combination, of the features disclosed in this specification (including any accompanying claims, abstract and drawings), or to any novel one, or any novel combination, of the steps of any method or process so disclosed.

1. A self-powered and self-sensing MR damping device, comprising:
an MR damper part having a damper piston assembly and a damper cylinder, the damper piston assembly being movable relative to the damper cylinder under an external excitation;
a power generator configured to generate electrical power according to the relative movement between the damper piston assembly and the damper cylinder; and
an electrical circuit configured to estimate said relative movement to output a damper driving current based on an estimated velocity,
wherein the MR damper part is further configured to generate a damper force according to the damper driving current.

2. A device according to claim 1, wherein there are provided MR fluids, i.e. an annular fluid orifice between the damper cylinder and the damper piston assembly.

3. A device according to claim 2, wherein there is provided at least one coil winding on the damper piston assembly, the coil winding being configured to receive said damper driving current to create a magnetic field of the MR fluids so as to effect the damping force of said damping device.

4. A device according to claim 1, further comprising:
a sensing part configured to sense the relative movement of the damper piston assembly and the damper cylinder.

5. A device according to claim 4, wherein the sensing part further comprises:
a piston rod movable as the damper piston assembly moves;
an outer cylinder movable as the damper cylinder moves; and
a multi-layer coil,
wherein, if the damper piston assembly and the damper cylinder move relative to each other under an external excitation, there will be a corresponding relative movement between the piston rod and the outer cylinder, which in turn results in that a number of turns of the coil enclosed by a flux path through the multi-layer coil will change, so as to generate a voltage in multi-layer coil that is proportional to a relative velocity between the piston rod and the outer cylinder.

6. A device according to claim 5, wherein the sensing part further comprises:
a radially magnetized ring magnet attached to the outer cylinder; and
a bobbin attached to the outer cylinder for receiving said multi-layer coil.

7. A device according to claim 6, wherein the sensing part further comprises:
a high-permeability spacer concentrically mounted on the rod; and
a non-magnetic magnetic flux shield segment mounted between the rod and said MR damper part.

8. A device according to claim 6, wherein the sensing part further comprises:
a high-permeability washer concentrically mounted on a high-permeability rod; and
a radially magnetized ring magnet concentrically mounted on the washer.

9. A device according to claim 1, wherein the MR damper part is inside the power generator.

10. A device according to claim 1, wherein the power generator is concentric with the MR damper part, and is located outside of the MR damper part.

11. A device according to claim 1, wherein the power generator comprises an inner assembly and an outer assembly, the inner assembly and the outer assembly being connected to the damper piston assembly and the damper cylinder, respectively.

12. A device according to claim 11, wherein the inner assembly comprises at least one pole piece and permanent magnet and the outer assembly comprises at least one winding coil.

13. A device according to claim 1, wherein there is provided a magnetic-field interaction assembly between the power generator and the MR damper part.

14. A device according to claim 1, wherein the electrical circuit further comprises:
a sensing estimator configured to estimate the electrical power generated by the power generator to output information on a relative velocity of the damper piston assembly and the damper cylinder.

15. A device according to claim 14, wherein the electrical circuit further comprises:
a controller configured to generate a command voltage according to the information on said relative velocity; and
a current driver configured to convert the generated command voltage into the damper driving current for activating MR fluids in the damper cylinder so as to generate said damper force.

16. A device according to claim 15, wherein the electrical circuit further comprises:
an energy harvesting unit configured to harvest the generated electrical power from said power generator and provide power to the sensing estimator, the sensing estimator and the current driver.

17. A device according to claim 16, wherein the energy harvesting unit further comprises:
a power conditioning circuit configured to rectify said electrical power to DC voltage;
an energy storage device configured to receive the DC voltage, the received DC voltage being for charging the energy storage device; and
a voltage regulator configured to adjust the DC voltage from the energy storage device to appropriate values for the sensing estimator, the sensing estimator and the current driver, respectively.

18. A device according to claim 5, wherein the electrical circuit further comprises:
a sensing estimator configured to receive an output voltage in the multi-layer coil from the sensing part, which is proportional to the relative velocity between the piston rod and the outer cylinder of the sensing part.

19. A device according to claim 1, wherein the MR damper part is configured to provide a hollow, and
wherein the hollow and the damper piston assembly are positioned such that at least one working portion is defined.

20. A device according to claim 19, wherein the piston assembly has at least one magnetic field generator that generates a magnetic field to act on MR fluid in the damper cylinder.

21. A device according to claim 13, wherein the magnetic-field interaction assembly further comprises a non-magnetic magnetic flux shield layer and a high-permeability magnetic flux guided layer.

22. A device according to claim 1, wherein the power generator further comprises:
an inner assembly having at least one group of a ring permanent magnet and a pole piece; and
an outer assembly having at least one group of a coil winding and a high-permeability spacer to form a slotted structure.

23. A device according to claim 22, wherein the outer assembly further comprises a high-permeability shell outside the coil winding and high-permeability spacer.

24. A device according to claim 1, wherein the power generator further comprises:
an inner assembly having at least one group of a ring permanent magnet and a pole piece; and
an outer assembly having at least one coil winding to form a slotless structure, the outer assembly further having a high-permeability shell outside the coil winding.

25. A device according to claim 1, wherein the power generator further comprises:
an inner assembly having at least one group of ring permanent magnet and pole piece;
a non-magnetic spring connected to the inner assembly; and
an outer assembly having at least one group of coil winding and high-permeability spacer to form a slotted structure, and having a high-permeability shell outside the coil-spacer groups.

26. A device according to claim 1, wherein the power generator further comprises:
an inner assembly having at least one group of ring permanent magnet and pole piece;
a non-magnetic spring connected to the inner assembly; and
an outer assembly having at least one coil winding to form a slotless structure and having a high-permeability shell outside the coil windings.

27. A self-powered and self-sensing MR damping device, comprising:
an MR damper part having a damper piston assembly and a damper cylinder, the damper piston assembly being movable relative to the damper cylinder under an external excitation;
a power generator configured to generate electrical power according to the relative movement between the damper piston assembly and said damper cylinder; and
a sensing part configured to sense the relative movement of the damper piston assembly and the damper cylinder.

28. A device according to claim 27, wherein there are provided MR fluids, i.e. an annular fluid orifice between the damper cylinder and the damper piston assembly.

29. A device according to claim 28, wherein there is provided at least one coil winding on the damper piston assembly, the coil winding being configured to receive damper driving current to create a magnetic field of the MR fluids so as to effect a damping force of said damping device.

30. A device according to claim 27, wherein the sensing part further comprises:
a piston rod movable as the damper piston assembly moves;
a outer cylinder movable as the damper cylinder moves; and
a multi-layer coil,
wherein, if the damper piston assembly and the damper cylinder move relative to each other under an external excitation, there will be a corresponding relative movement between the piston rod and the outer cylinder, which in turn results in that a number of turns of the coil enclosed by a flux path through the coil will change, so as to generate a voltage in the coil that is proportional to a relative velocity between piston rod and the outer cylinder.

31. A device according to claim 30, wherein the sensing part further comprises:
a radially magnetized ring magnet attached to the outer cylinder; and
a bobbin attached to the outer cylinder for receiving said multi-layer coil.

32. A device according to claim 31, wherein the sensing part further comprises:
a high-permeability spacer concentrically mounted on the rod; and
a non-magnetic magnetic flux shield segment mounted between the rod and said MR damper part.

33. A device according to claim 31, wherein the sensing part further comprises:
a high-permeability washer concentrically mounted on a high-permeability rod; and
a radially magnetized ring magnet concentrically mounted on the washer.

34. A device according to claim 27, wherein the MR damper part is inside the power generator.

35. A device according to claim 27, wherein the power generator is concentric with the MR damper part, and is located outside of the MR damper part.

36. A device according to claim 27, wherein the power generator comprises an inner assembly and an outer assembly, the inner assembly and the outer assembly being connected to the damper piston assembly and the damper cylinder, respectively.

37. A device according to claim 36, wherein the inner assembly comprises at least one pole piece and permanent magnet and the outer assembly comprises at least one winding coil.

38. A device according to claim 27, wherein there is provided a magnetic-field interaction assembly between the power generator and the MR damper part.

39. An electrical circuit for a self-powered and self-sensing MR damping device, wherein the device comprises:
an MR damper part having a damper piston assembly and a damper cylinder, the damper piston assembly being movable relative to the damper cylinder under an external excitation;
a power generator configured to generate electrical power according to the relative movement between the damper piston assembly and said damper cylinder; and
a sensing part configured to sense the relative movement of the damper piston assembly and the damper cylinder, and
wherein the electrical circuit comprises:
a sensing estimator configured to receive information on the relative movement sensed by the sensing part, or to estimate the electrical power generated by the power generator to output information on a relative velocity of the damper piston assembly and the damper cylinder.

40. An electrical circuit according to claim 39, further comprising:
a controller configured to generate a command voltage according to the information on said relative velocity; and
a current driver configured to convert the generated command into driving current for activating MR fluids in the damper cylinder.

41. An electrical circuit according to claim 39, further comprising:
an energy harvesting unit configured to harvest the generated electrical power from said power generator and provide power to the sensing estimator and the current driver.

42. An electrical circuit according to claim 41, wherein the energy harvesting unit further comprises:
a power conditioning circuit configured to rectify said electrical power to DC voltage;
an energy storage device configured to receive the DC voltage for charging the energy storage device; and
a voltage regulator configured to adjust the DC voltage from the energy storage device to appropriate values for the sensing estimator and the current driver, respectively.
